(19) United States
(12) Patent Application Publication
(10) Pub. No.: US 2005/0153720 A1
(43) Pub. Date: Jul. 14, 2005

(54) Apparatus, system, and method for managing distribution and coverage channels in a cellular communication system having a wireless backhaul

(76) Inventors: Graeme E. White, Coomera (AU); Fraser Clayton, Wheelers Hill (AU)

Correspondence Address: DUANE MORRIS, LLP;IP DEPARTMENT, ONE LIBERTY PLACE, PHILADELPHIA, PA, 19103-7396, US

(21) Appl. No.: 11/012,544

(22) Filed: Dec. 14, 2004

Related U.S. Application Data
(60) Provisional application No. 60/529,730, filed on Dec. 15, 2003.

(51) Int. Cl. H04Q 7/20

(52) U.S. Cl. 455/500; 455/509

(57) ABSTRACT

An apparatus, system and method provide management of distribution channels and coverage channels in a communication system having a wireless backhaul. Based on coverage channel information and distribution channel information provided by an OMC, a base station distinguishes between a physical distribution channel between the base station and a distribution station and a physical coverage channel between the distribution station and a mobile station. The base station forms a downstream distribution signal including coverage channel information. The downstream distribution signal is transmitted at the distribution channel associated with the coverage channel identified by the coverage channel information.

### RELATED APPLICATIONS

This application is related to and claims priority of U.S. provisional application Ser. No. 60/529,730 filed Dec. 15, 2003.

### BACKGROUND OF THE INVENTION

The invention relates in general to wireless communication and more specifically to managing distribution channels and coverage channels in cellular systems having a wireless backhaul.

Cellular communication systems provide wireless service to mobile stations using base stations where each base station provides service to mobile stations within a cell corresponding to the particular base station. Communication channel resources are distributed between the base stations allowing for channel re-use in cells that are separated at sufficient distance. In systems using frequency division techniques, for example, frequency bandwidth is distributed between the base stations allowing for frequency re-use in cells that are sufficiently separated to avoid interference. In many cellular systems, the base station communicates directly with mobile stations within the cell using the coverage frequencies assigned to the cell. In such conventional communication systems, the base station transmits one or more signals that identify communication channels, such as coverage frequencies, for use by the mobile stations for communicating with the base station. The signals transmitted by the base station, therefore, conform to the channel allocation scheme represented by the identified communication channels. For example, in a conventional Global System for Mobile Communication (GSM) system, a Broadcast Control Channel (BCCH) signal, among other GSM signals, includes frequency information identifying the frequencies that are to be used by the mobile station for communication. The frequency of the BCCH signal matches the frequency information described in the BCCH signal.

A system in accordance with the description in U.S. Pat. No. 5,787,344 issued to Stefan Scheinert on Jul. 28, 1998, entitled “Arrangement of Base Transceiver Stations of an Area-Covering Network”, however, provides service to mobile stations through clusters of distribution stations connected through a wireless backhaul. In such systems, a base interface station connected to the base station communicates with the base station using coverage frequencies while communicating with the distribution stations using distribution frequencies. The distribution stations communicate with the mobile stations using the same coverage frequencies used between the base station and the base interface station to provide a transparent interface between the mobile stations and the base station. The channel information in the distribution signals, therefore, does not explicitly identify the distribution channel at which the distribution signals are transmitted. Since the distribution stations frequency shift the distribution signals to the appropriate coverage frequencies, the coverage signals used by the mobile stations conform to the particular system protocol. Frequency information within a coverage signal, therefore, matches the coverage signal carrier frequency. A conventional cellular system can easily be adapted to include the base interface station and distribution stations without modifying the existing base station. Additional equipment must be installed, however, to maintain the transparent interface between the base station and the mobile stations resulting in unused, under utilized, or redundant components.

Therefore, there is need for an apparatus, system and method for efficiently managing distribution channels and coverage channels in a cellular communication system with a wireless backhaul.

### BRIEF DESCRIPTION OF THE DRAWINGS

FIG. 1 is a block diagram of a cellular communication system using a wireless backhaul in accordance with an exemplary embodiment of the invention.

FIG. 2 is a block diagram of a cellular communication system in accordance with the exemplary embodiment where the communication link for transmitting the distribution channel information includes a frequency translation interface.

FIG. 3 is a block diagram of a channel translation index in accordance with the exemplary embodiment of the invention.

FIG. 4 is a block diagram of a downstream distribution signal in accordance with the exemplary embodiment of the invention.

FIG. 5 is a flow chart of a method of communication performed in the base station in accordance with the exemplary embodiment of the invention.

### DETAILED DESCRIPTION OF THE PREFERRED EMBODIMENTS

In an exemplary embodiment of the invention, an apparatus, system and method efficiently manage distribution channels and coverage channels in a cellular communication system with a wireless backhaul. The base station transmits distribution signals through distribution channels where coverage channel information included in the distribution signals conforms to the coverage channel allocation plan of the system and indicates the coverage channel to be used by the mobile station.

In the exemplary embodiment, an Operation and Maintenance Center (OMC) provides instructions and information to the base station to execute a desired channel allocation scheme. The base station receives the coverage channel information as well as distribution channel information and transmits, using a distribution channel, a distribution signal that includes information identifying at least one coverage channel. The base station may receive the distribution channel information using any one of several techniques depending on the particular implementation. For example, the distribution information may be transmitted through a communication link utilizing the conventional control and data communication resources within the system. Another suitable implementation does not require modification of the system protocol and includes communication hardware and software that facilitates sending the distribution channel information through a separate communication link. The distribution channel information may include any of several types of information that conveys the appropriate distribution channels that the base station is directed to use in communicating with the distribution stations. In the exemplary embodiment, a distribution channel allocation message received at the base station provides a channel translation between the coverage channels and distribution channels.

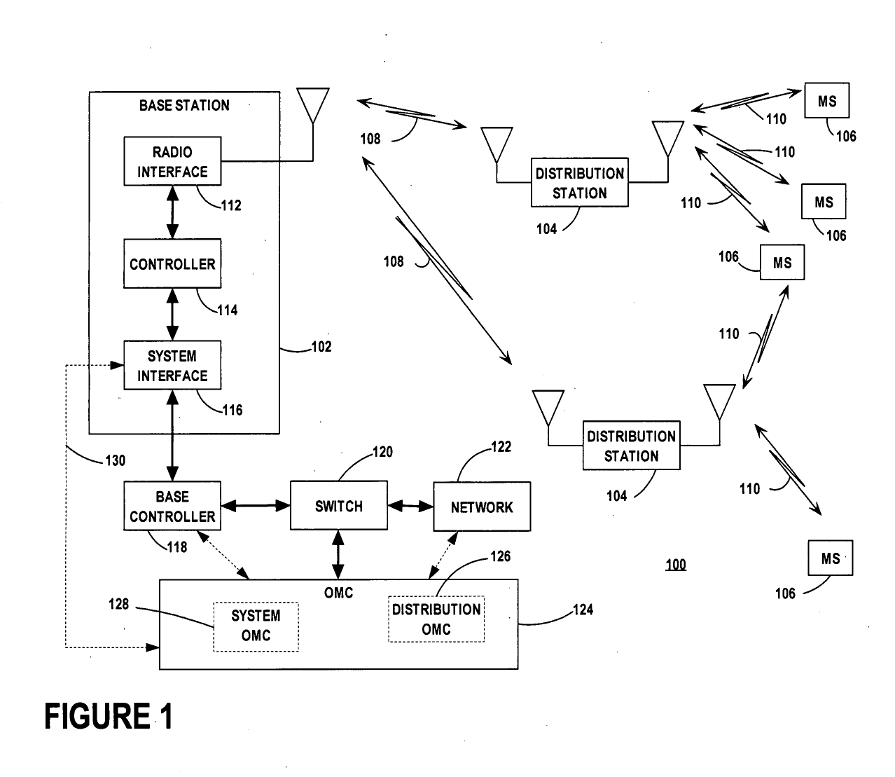

FIG. 1 is a block diagram of a communication system 100 with a wireless backhaul in accordance with the exemplary embodiment of the invention. The communication system 100 includes at least one base station 102 and at least one distribution station 104. In the exemplary embodiment, a geographic region is divided into cells where a single base station 102 provides wireless service to mobile stations 106 within a cell through clusters of distribution stations 104 located within the cell. The base station 102 communicates with distribution stations 104 through a distribution channel 108 and the distribution stations 104 communicate with mobile stations through a coverage channel 110. The distribution channel 108 and the coverage channel 110 are physical channels that may contain any number of distinct communication channels. For example, the distribution channel 108 and the coverage channel 110 may be divided using code division multiple access (CDMA) techniques to provide several distinct communication channels. In the exemplary embodiment, the communication system 100 is implemented in accordance with Global System for Mobile Communication (GSM) protocols and is a multi-carrier, Time Division Multiple Access (TDMA) system 100 where resources of the channels 108, 110 are divided employing a combination of Frequency Division Multiple Access (FDMA) and TDMA techniques. In the exemplary embodiment, therefore, distribution signals are transmitted at distribution frequencies in the distribution channel and coverage signals are transmitted at coverage frequencies in the coverage channel. Although the description of the exemplary embodiment refers to channels having different frequencies within the distribution channel 108 and the coverage channel 110, the teachings described herein can be applied in accordance with known techniques to other types of channels without limitation of the invention.

In the exemplary embodiment, the base station 102 administers the frequency allocation scheme as directed by the OMC 124 and manages the distribution channels 108 and the coverage channels 110 by distinguishing between two physical channels (108, 110) based on the distribution channel information provided by the OMC 124. The distribution channel 108 is a physical channel between the base station 102 and one or more distribution stations 104 that uses distribution frequencies while the coverage channel 110 is a physical channel between the distribution stations 104 and the mobile stations 106 that uses coverage frequencies. In response to information provided by the OMC 124, the base station 102 maintains and tracks the relationship between the two physical channels 108, 110 and facilitates the operation of the wireless backhaul system 100 without the need for installation of additional equipment at the base station 102. Base station 102 components such as amplifiers and diversity combining systems are not duplicated or underutilized.

Any of several frequency allocation schemes can be used to allocate frequency spectrum between the cells and within a cell between different clusters of distribution stations 104. Examples of suitable frequency allocation techniques are discussed in detail in U.S. Pat. No. 5,787,344 issued to Stefan Scheinert on Jul. 28, 1998, entitled “Arrangement of Base Transceiver Stations of an Area-Covering Network” which is incorporated by reference herein.

As explained above, the base station 102 communicates through a distribution channel 108 with the distribution stations 104 using distribution signals while corresponding coverage signals are exchanged through a coverage channel 110 between the distribution stations 104 and the mobile stations 106. In the exemplary embodiment, the base station 102 transmits a downstream distribution signal at a downstream distribution frequency to several distribution stations 104 within a cluster through the distribution channel 108. The distribution stations 104 frequency shift the downstream distribution signal to a downstream coverage frequency to form a downstream coverage signal. Each of the distribution stations 104 within the cluster transmits the downstream coverage signal to mobile stations 106 within the service area of a cluster. Therefore, in the exemplary embodiment, the cluster of distribution stations 104 simulcasts the downstream coverage signal to the mobile stations 106 within the service area of the cluster. Multiple downstream coverage signals received at a particular mobile station 106 are treated by the mobile station 106 in a similar manner to receiving multi-path signals in a conventional cellular communication system where a multi-path channel exists.

In the upstream direction, the one or more distribution stations 104 receive an upstream coverage signal transmitted from a mobile station 106 at an upstream coverage frequency. The distribution stations 104 frequency shift the upstream coverage signal to an upstream distribution frequency and transmit the resulting upstream distribution signal to the base station 102. Multiple distribution stations 104 may receive the upstream coverage signal from a particular mobile station 106 and transmit corresponding upstream distribution signals to the base station 102. The distribution channel 108, therefore, may contain multiple versions of an upstream distribution signal. Those skilled in the art will recognize that the resulting upstream distribution channel has characteristics similar to a multi-path wireless channel where multiple versions of a signal are received through the channel. The base station 102 deciphers the multiple upstream distribution signals in accordance with known techniques to receive the upstream distribution signal.

The distribution channel 108 and coverage channel 110 may each be defined to include several channels, frequencies or sets of frequencies. In some situations, a particular channel or frequency of the distribution channel 108 may be used within a coverage channel 110 of another cell. Further, the distribution channel 108 may include downstream distribution channels (108) that are used as upstream coverage channels (110) in the coverage channel 110 in circumstances. Where the communication system 100 is a GSM system, the downstream and upstream communication directions are typically referred to as “downlink” and “uplink”, respectively.

A radio interface 112 in the base station 102 includes appropriate hardware and software for communicating through the distribution channel 108. The radio interface 112 is a transceiver having a transmitter and a receiver configured to transmit and receive radio frequency (RF) signals. As is known, the radio interface 112 in a conventional GSM base station includes several transceivers operating at different frequencies.

A controller 114 connected to the radio interface 112 facilitates the overall functionality of the base station 102 in addition to interfacing with the other components of the base station 102 to perform the functions described herein. The system interface 116 includes hardware and software for communicating with a base controller 118 of the communication system 100. The base station 102 may include other components and software for performing other services and tasks. The various functions of the radio interface 112, controller 114, and the system interface 116 may be implemented in any combination of hardware, software or firmware. Therefore, the various functional blocks in FIG. 1 are presented for illustrative purposes and the described functions may performed in any of several component configurations or circuitry.

As mentioned above, the exemplary communication system 100 operates in accordance with Global System for Mobile Communication (GSM) techniques although the present invention can be used in accordance with any number of communication systems and protocols. In addition to other functions described herein, the base station 102 performs the functions of a base transceiver station (BTS) in the exemplary embodiment. The base station 102 manages the air interface to the mobile stations 106 including radio signal transmission and reception, measurement and forwarding of communication distribution parameters to the base controller 118, multiplexing, channel coding, channel decoding, encryption, decryption, and interleaving.

In the exemplary embodiment, the base controller 118 manages the radio resources for a group of base stations 102. Where the communication system 100 is arranged in accordance with GSM techniques, the base controller 118 performs the functions of a base station controller (BSC). The base controller 118 manages all radio related functions, including configuration of the radio interface 112 and general base station 102 administration, establishment and supervision of the connections to the mobile stations 106, allocation of radio resources and the analysis of radio connection parameters. Examples of tasks performed by the base controller 118 include call maintenance such as evaluations to initiate handoffs and the change of the transmission power of a base station 102. Therefore, in addition to the other functions described herein, the base station 102 and the base controller 118 collectively perform the functions of a base station system (BSS) where the system 100 operates in accordance with GSM techniques.

A switch 120 provides services and coordination between the mobile stations 106 and external networks 122. In a GSM system, the switch 120 performs the functions of a mobile switching center (MSC). Examples of functions performed by the switch 120 include registration, authentication, location updating, hand-over procedure and call routing for a roaming subscriber.

The switch 120 is connected to a network 122 such as a public switched telephone network (PSTN) which provides a connection to external communication networks and services. The OMC (Operation and Maintenance Center) 124 includes hardware and software for monitoring and managing the operation of the base station 102, base controller 118, switch 120 and distribution station 104. The OMC 124 may comprise two separate OMCs (126, 128). A distribution OMC 126 manages the operation of the distribution stations 104 and the functions of the base station 102 associated with the operation of the distribution channel 108 between the base station 102 and distribution station 104. A system OMC 128 manages the portions of the system 100 not directly related to the wireless backhaul and performs the functions of a GSM OMC where the system is implemented in accordance with GSM techniques. The distribution OMC 126 and the system OMC 128 are represented with boxes having dashed lines to illustrate that these functions may be integrated within one OMC, performed in separate devices that are co-located, or in separate devices that are connected within the system 100 at different locations. Further, the OMCs 124, 126, 128 may be connected to the components of the system 100 using various techniques. For example, an OMC 124, 126, 128 may be connected through a PSTN or may use various communications resources such as wireless links or modems to connect to equipment within the system 100.

In addition to performing conventional management and monitoring functions, the OMC 124 provides the base station 102 with the distribution channel information and the coverage channel information. The information may be provided using any one of several techniques depending on the particular implementation of the communication system 100. The OMC 124, for example, may communicate through the base controller 118 using the system control resources. In such an implementation, the signaling protocol between the various functional blocks must support transmission of the distribution channel information as well as coverage channel information. In some systems, therefore, the conventional signaling must be modified in order to allow transmission of the distribution channel information. The GSM protocol, for example, does not provide for a distribution frequency information to be transmitted to the base station 102 from the OMC 124 and a modification of the standard GSM signaling protocol would be required if the distribution channel information is transmitted through the base controller 118. Based on the teachings herein and in accordance with known techniques, those skilled in the art will recognize the various techniques for implementing such a modification. Other techniques may include transmitting at least the distribution channel information through a communication link other than a communication link 130 that utilizes the base controller 118. As discussed below in further detail, the distribution channel information is transmitted through a frequency translation interface connected to the base station 102 in the exemplary embodiment and modification of the signaling protocol through the system 100 is avoided.

The distribution channel information includes sufficient information for the base station 102 to identify the distribution channels and, in some circumstances, may include the actual upstream and downstream distribution channel values such as distribution frequency values. Where the distribution channel information is transmitted through a communication link 130 including convention system components, the conventional protocol is adapted to convey the distribution channel values, value pairs or other distribution channel information. In the exemplary embodiment, however, the distribution channel information includes a channel translation index that is transmitted from the distribution OMC 126 to the base station 102. The channel translation index may be implemented as a channel translation “look-up” table that indicates the desired channel association between the coverage channels and the distribution channels. When forming and transmitting a distribution signal, the base station 102 uses the channel translation index to determine the appropriate distribution channel. In a system 100 where the channels are frequencies, the channel translation index may include frequency values indicating individual frequencies, groups of frequencies or frequency pairs.

An example of another technique for conveying the association between distribution channels and coverage channels includes manually setting the required coverage and distribution channels at the OMC 124 where there is no fixed translation between the coverage and distribution channels except that the spacing between these channels must conform to certain rules and the OMC 124. The translation information is conveyed from the OMC 124 to the base controller 118 and base station 102.

In some circumstances, the system 100 may determine the appropriate channel allocation of distribution channels and coverage channels based on system analysis observing characteristics in the radio environment such as interference. The channels are allocated to maximize performance while conforming with channel allocations rules governing requirements such as a minimum channel spacing.

In the exemplary embodiment, the base station 102 forms a downstream distribution signal based on the coverage channel information as well as other data and control signals received through the Abis interface from the base controller 118. The signal is formed in accordance with conventional GSM techniques except that the base station 102 transmits the downstream distribution signal using the distribution frequency rather than the coverage frequency. The base station 102 receives the coverage frequency information from the base controller 118 and forms the downstream distribution signal in accordance with known techniques and applies the defined channel translation to direct the signal to the appropriate transceiver in the radio interface 112. The base station 102 in the exemplary GSM communication system, therefore, forms and transmits downstream signals in accordance with conventional techniques except that the downstream signal is transmitted at a downstream distribution frequency where the downstream distribution frequency is based on the downstream coverage frequency described in the downstream signal and a frequency translation reflected in the frequency translation index. The combination of logical channels, therefore, that would normally be used in forming the coverage signals in a conventional GSM system are also used in forming the distribution signals in the exemplary embodiment where the base station 102 transmits the distribution signal using a distribution frequency instead of a coverage frequency and the distribution frequency is derived from the coverage frequency using a known translation.

The base station 102, therefore, processes the incoming signals and data in accordance with known techniques except for responding to coverage channel information received through the system interface. In conventional GSM systems, the coverage channel information received through Abis interface is used to create a downstream signal while also allowing the base station 102 to direct the created downstream signal to the transmitter that is tuned to the coverage frequency described in the coverage channel information. In the exemplary embodiment of the invention, however, the channel translation index is used to reference the coverage channel information to the associated distribution channel information. The distribution signal is forwarded to the transmitter corresponding to the distribution frequency identified by the channel translation index.

The downstream signal may be a control signal that includes the coverage channel information where the control signal may be identical to a conventional control signal except that the channel identified in the control signal is different than the transmission channel. In a conventional GSM system, a BCCH signal provides coverage channel information to the mobile stations 106 indicating which frequencies are available for the mobile station 106 to use for communication. In an embodiment of the invention utilizing the GSM protocol, a BCCH signal transmitted from the base station 102 contains coverage frequency information that does not describe the distribution frequencies used to transmit the BCCH signal to the distribution stations 104. The distribution frequency of the distribution signal is not reflected in the frequency information contained in the distribution signal. Accordingly, a BCCH signal transmitted at a downstream distribution frequency does not conform to the conventional GSM protocol since frequency information described in the signal does not match the distribution frequency. Since the distribution station 104 frequency shifts the distribution signal to the appropriate coverage frequency, the BCCH signal conforms to the GSM standard when received by the mobile station 106.

At the distribution stations 104, the appropriate frequency translation are applied to upstream coverage signals to create upstream distribution signals in the exemplary embodiment. The upstream distribution signal is processed at the base station 102 in accordance with the frequency translation in order that the received signal is properly interpreted by the system 100 as originating at the upstream coverage frequency. For example, if an upstream coverage signal is transmitted from the mobile station 106 to the distribution station 104 at F1 and the distribution station 104 transmits the corresponding upstream distribution signal at F2, the information correlating F1 and F2 is maintained by a combination of the base station 102 and the base controller 118. In some situations data manipulation at the base station 102 allows all correlation information to be handled by the base station 102. In other situations, the base controller 118 may track the correlation information allowing the base station 102 to only forward information identifying the upstream signal. The correlation between the upstream coverage channels and the upstream distribution channels may be useful for a variety of reasons. In particular, power control management in a GSM-based system 100 may require that upstream distribution frequencies be correlated to the originating upstream coverage frequencies in order that appropriate power control information is sent to the mobile stations 106. In some situations, therefore, the signal strength of received upstream distribution signals are measured at the base station 102 and forwarded to the base controller 118 allowing the base controller 118 to properly manage output power of the mobile stations 106. In some circumstances, however, the signal strength of an upstream coverage signal transmitted from a mobile station 106 is measured at the distribution station 104 and forwarded to the base controller 118.

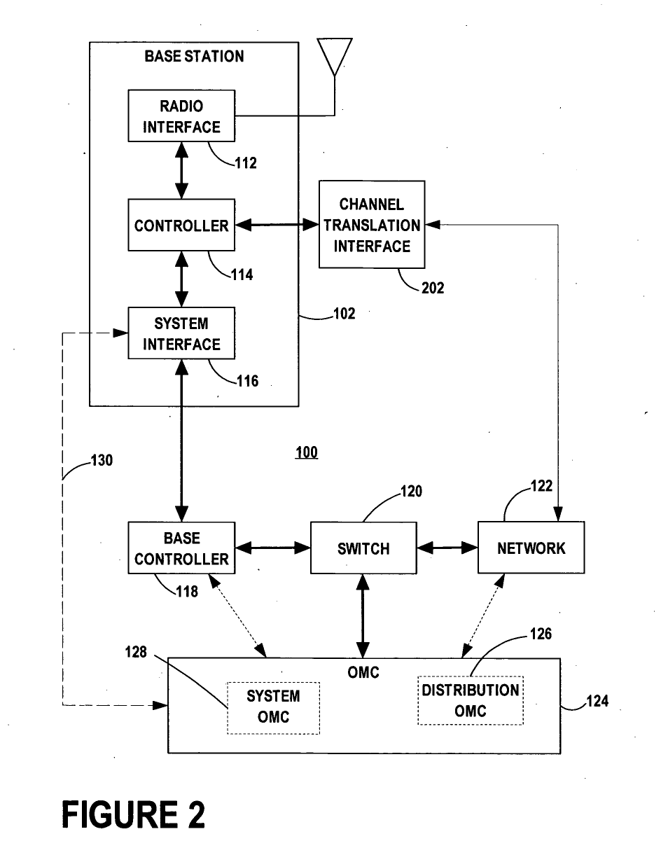

FIG. 2 is a block diagram of a portion of the communication system 100 in accordance with the exemplary embodiment where the communication link 130 for transmitting the distribution channel information includes a channel translation interface 202. In the exemplary embodiment, the distribution channel information is transmitted to the base station through a channel translation interface 202 connected to the controller 114 in the base station 102 while other data transmission and instruction is performed in accordance with standard protocols through the switch 120 and base controller 118 using conventional communication protocols. A suitable implementation of the channel translation interface 202 includes a modem connected to the OMC 126 through the network 122. Transmission may be performed exclusively through a wire-line network such as PSTN or at least partially through a wireless link. The channel translation interface 202 communicates with the OMC 126 and provides the controller 114 with the appropriate information to create the channel translation index. For example, the OMC 126 may transmit a channel translation message including the channel translation index directly to the frequency translation interface 202. The channel translation interface 202 provides the channel translation index to the controller 114 that stores the index in memory. The controller 114 can access the channel translation index as needed. The channel translation index may be updated as required by the OMC 126. Updates may be performed by sending an entirely new channel translation index that is used to overwrite the previous channel translation index. In some circumstances, the channel translation message transmitted by the OMC may contain only new information thereby avoiding the transmission of data already accurately contained in the channel translation index. Based on these teachings and known techniques, those skilled in the art will recognize the various implementations of the communication link 130 that includes a channel translation interface 202.

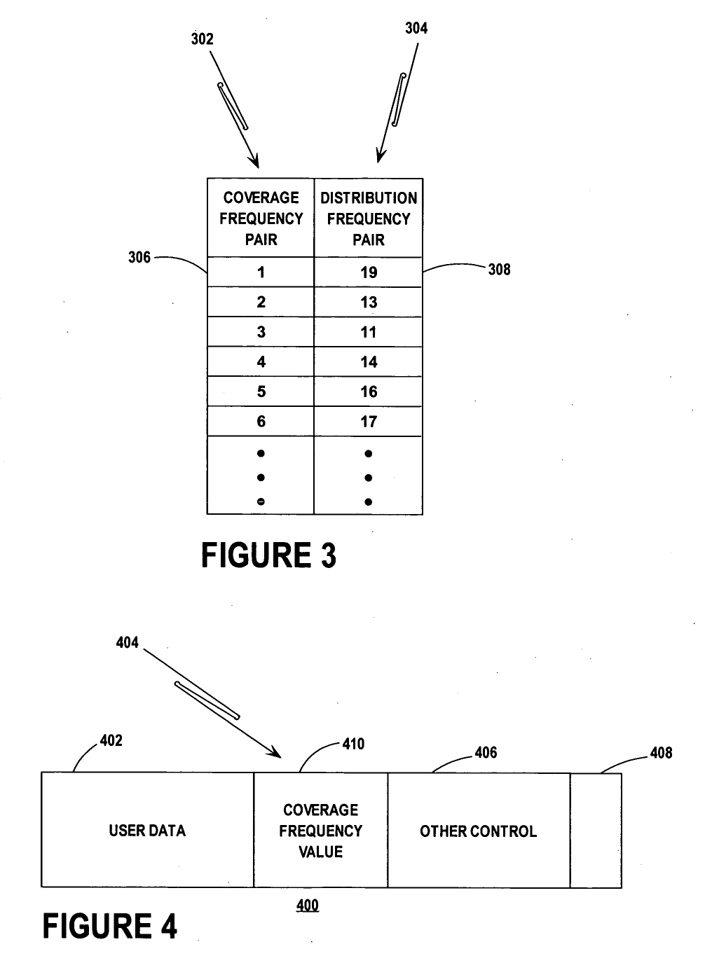

FIG. 3 is a block diagram of a channel translation index 300 illustrating a suitable format and content of the distribution channel information in accordance with the exemplary embodiment of the invention. The distribution channel information may include a variety of tables, indexes, offset values, channel values or other information conveying the appropriate channel translation directed by the OMC 126. A suitable implementation for maintaining the channel translation includes storing a “look-up” table in memory (not shown) where the look-up table correlates each coverage frequency to a distribution frequency. In the exemplary embodiment, however, a channel translation index 300 provides a channel translation between coverage frequency pairs and distribution frequency pairs. As explained above, the distribution channel information may be transmitted and stored in variety of ways. In the exemplary embodiment, coverage channel frequencies are received through the Abis interface in accordance with known techniques. By providing a frequency translation, the OMC 126 can direct the base station 102 to utilize distribution frequencies that correspond to the received coverage frequencies. Since GSM protocols are used in the exemplary embodiment, each coverage frequency pair 302 can be associated with a distribution frequency pair 304. A coverage frequency pair 302 and a distribution frequency pair 304 in the exemplary embodiment, each define a downstream (downlink) and an upstream (uplink) frequency pair where the two frequencies are separated by a known offset. When the base station 102 receives information that would require a transmission at coverage frequency pair “1” 306 in a conventional system, the base station 102 identifies the distribution frequency pair 308 associated with the coverage frequency pair 306 using the channel translation index 300 and transmits the downstream distribution signal at the distribution frequency of the “19” distribution frequency pair 308.

The base station 102 forms the downstream distribution signal to include the coverage frequency value 306 in accordance with the appropriate protocol. In the exemplary embodiment, the downstream distribution signal and the upstream distribution signal are wirelessly transmitted in accordance with the GSM air interface. FIG. 4 is a block diagram of the downstream distribution signal 400 in accordance with the exemplary embodiment of the invention. The distribution station 104 receives the downstream distribution signal 400 and transmits a corresponding downstream coverage signal to the mobile station. The downstream coverage signal corresponding to the downstream distribution signal 400 may be any one of several signals transmitted to the mobile station 106 that provides frequency information to the mobile station 106. An example of a downstream coverage signal including frequency information is a Broadcast Control Channel (BCCH) as defined in a GSM air interface. The BCCH includes information regarding the system parameters and synchronization, coverage channel information for the base station 102 and coverage channel information for the surrounding base stations (102). In the exemplary embodiment, the downstream coverage signal is the same as the downstream distribution signal 400 except that the downstream distribution signal 400 is transmitted at the downstream distribution frequency and the downstream coverage signal is transmitted at the downstream coverage frequency.

The downstream distribution signal 400 includes at least coverage channel information 404. The downstream distribution signal 400 may include other information such user data 402 and other control signals 406 and information 408. In the exemplary embodiment, the coverage frequency value 410 represents the coverage channel information received at the base station 102 through the Abis interface. The coverage frequency value 410, therefore, may represent a downstream coverage frequency or an upstream coverage frequency. In some circumstances the coverage frequency value 410 may represent a pair of frequencies or multiple frequencies or pairs of frequencies. In the exemplary embodiment, the coverage frequency value 410 represents a coverage frequency pair that includes the upstream coverage frequency and the downstream coverage frequency in accordance with the GSM protocol. Typically, this representation includes only the downstream frequency since offset is known and the upstream frequency can be determined. In the exemplary embodiment, the coverage channel information 404 is identical to the coverage channel information received at the base station through the Abis interface. The coverage channel information 404 in the downstream distribution signal 400, however, may include less or more information or may be formatted differently, than the coverage channel information received at the base station 102 in some circumstances depending on the particular implementation of the communication system 100.

In the exemplary embodiment, therefore, the OMC 124 manages distribution channels and the coverage channels by providing channel allocation information to the base controller 118 as well as providing the channel translation information to the base station 102. Conventional techniques are used to manage the coverage channels used by the mobile stations 106 by transmitting the required information and instructions through the communication system 100 components. For example, the appropriate messages are transmitted using the SS7 and GSM protocols in a GSM system. As discussed above, the channel translation information is transmitted through a communication link 130 between the OMC 124 and the base station 102. In the exemplary embodiment, the communication link 130 is implemented between the OMC 124 and the base station 102 through a PSTN and a channel translation interface 202. The communication link 130, however, may be implemented through conventional system components using a modified protocol allowing for the transmission of the distribution channel information. The base station 102 applies the distribution channel information to incoming signal to create and transmit downstream distribution signals at a distribution frequency associated with the coverage frequency contained in the signal.

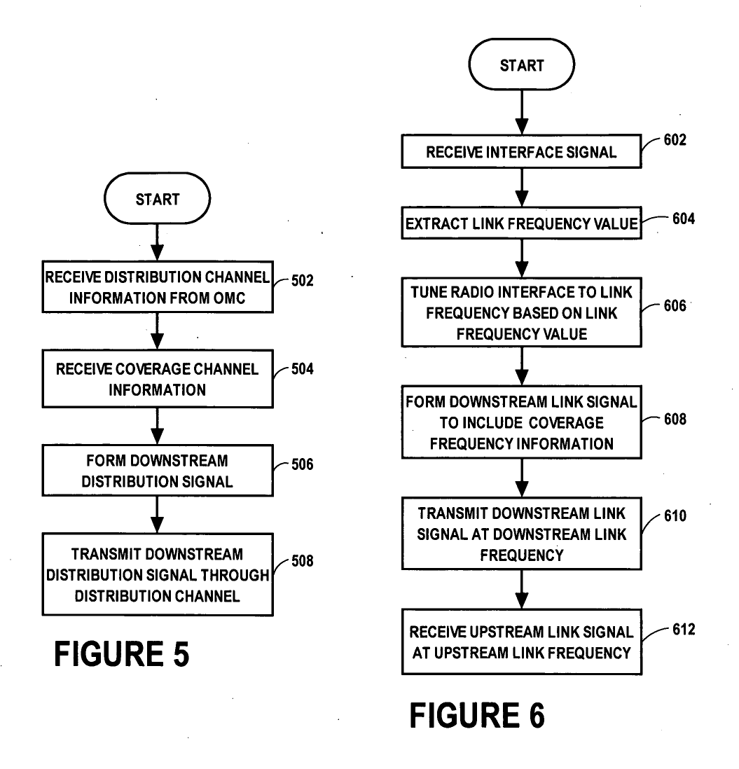

FIG. 5 is a flow chart of a method of communication performed at the base station 102 in accordance with the exemplary embodiment of the invention. The method may be performed using several techniques involving any combination of software, hardware, and firmware. In the exemplary embodiment, the controller 114 facilitates the exchange of signals through the system interface 116 and the radio interface 112. Software code running on the controller 114 facilitates the overall functionality of the base station 102 in addition to the functions described herein.

At step 502, the base station 102 receives the distribution channel information from the OMC 124. As described above, the distribution channel information may be received through conventional system components using a modified protocol or may be received through a separate communication link 130. In the exemplary embodiment, a channel translation index 300 is formed by the OMC 126 and transmitted within a channel translation message through the communication link 130 that includes a PSTN and a channel translation interface 202. The base station 102 stores the channel translation index 300 in memory. In most situations, step 502 is required only when the channel allocation scheme is changed. The allocation of distribution and coverage frequencies can be configured manually or automatically by the system or by a combination of both. For example, a qualified technician may enter information to configure the system 100 through a user interface such a computer connected to the OMC 126. Further, the OMC 126 may determine inefficiencies in the system 100 and reallocate frequencies to more efficiently uses resources such as bandwidth to improve performance. The distribution channel information may be generated in the OMC 126 and forwarded to the base controller 118. In some circumstances, the base controller 118 may generate the distribution channel information based on parameters set by the OMC 126.

At step 504, the base station 102 receives the coverage channel information. In the exemplary embodiment, the coverage channel information is received through the Abis interface using convention techniques.

At step 506, the base station 102 forms the downstream distribution signal. Based on the information received through the Abis interface, the base station 102 creates the downstream distribution signal that is formatted in accordance with the air interface protocol of the system 100. The base station 102 constructs the downstream distribution signal in accordance with known techniques of forming a coverage signal in conventional systems.

At step 508, the base station 102 transmits the downstream distribution signal 400 through the distribution channel 108. In the exemplary embodiment, the controller 114 in the base station 102 deciphers the coverage channel information received through the system interface 116 and applies the channel translation included in the channel translation index 300 to determine the appropriate distribution channel for transmission. The downstream distribution signal 400 is forwarded to the transmitter tuned to the distribution frequency and the downstream distribution signal 400 is transmitted at the downstream distribution frequency associated with the coverage channel information contained in the downstream distribution signal. The distribution station 104 applies a channel translation to shift the downstream distribution signal to the appropriate coverage frequency.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. A method performed in a base station communicatively connected within a cellular communication system, the method comprising:
receiving distribution channel information representing a distribution channel for communication between the base station and a distribution station;
receiving coverage channel information representing a coverage channel for communication between the distribution station and a mobile station; and
transmitting a wireless distribution signal using the distribution channel to the distribution station, the wireless distribution signal including the coverage channel information.

2. A method in accordance with claim 1, wherein receiving the distribution channel information comprises:
receiving a channel translation index correlating at least one coverage channel to an associated distribution channel.

3. A method in accordance with claim 2, wherein the coverage channel information indicates the coverage channel, the method further comprising:
applying the channel translation index to the coverage channel to determine the associated distribution channel; and
transmitting the wireless distribution signal at the associated distribution channel.

4. A method in accordance with claim 1, wherein the distribution channel information represents at least a downstream distribution frequency for transmitting a downstream distribution signal from the base station to the distribution station.

5. A method in accordance with claim 4, wherein the distribution frequency value represents at least a distribution frequency pair including the downstream distribution frequency and an upstream distribution frequency for transmitting an upstream distribution signal from the distribution station to the base station.

6. A method in accordance with claim 1, wherein the coverage channel information represents at least a downstream coverage frequency for transmitting a downstream coverage signal from the distribution station to the mobile station.

7. A method in accordance with claim 6, wherein the coverage channel information represents at least a coverage frequency pair including the downstream coverage frequency and an upstream coverage frequency for transmitting an upstream coverage signal from the mobile station to the distribution station.

8. A method performed in a base station communicatively connected within a cellular communication system comprising at least one distribution station in communication with the base station and providing wireless service to at least one mobile base station, the method comprising:
forming a downstream distribution signal including a coverage frequency value representing at least one coverage frequency for communication between the distribution station and the mobile station, the coverage frequency value received at the base station;
correlating the coverage frequency value to an associated distribution frequency value representing at least one distribution frequency for communication between the base station and the distribution station; and
transmitting the downstream distribution signal at the distribution frequency to the distribution station.

9. A method in accordance with claim 8, wherein the correlating comprises:
identifying the distribution frequency value as corresponding to the coverage frequency value in a channel translation index correlating a plurality of coverage frequency values to a plurality of distribution frequency values for communication between the base station and the distribution station, the coverage frequency values for communication between the distribution station and the mobile station.

10. A method in accordance with claim 9, further comprising:
receiving the channel translation index from an Operation and Maintenance Center (OMC).

11. A method in accordance with claim 10, wherein the receiving the channel translation index comprises receiving the channel translation index through a communication link comprising a channel translation interface.

12. A method in accordance with claim 11, wherein the distribution frequency value represents at least a distribution frequency pair including the downstream distribution frequency and an upstream distribution frequency for transmitting an upstream distribution signal from the distribution station to the base station.

13. A method in accordance with claim 12, wherein the coverage frequency value represents at least a coverage frequency pair including a downstream coverage frequency and an upstream coverage frequency for transmitting an upstream coverage signal from the mobile station to the distribution station.

14. A method in accordance with claim 13, further comprising:
receiving the coverage frequency value from a base controller through a Global System for Mobile Communication (GSM) Abis interface.

15. A base station comprising:
a system interface configured to receive coverage channel information;
a controller for correlating the coverage channel information to distribution channel information to determine a downstream distribution channel; and
a radio interface for transmitting, to a distribution station, a wireless distribution signal at the downstream distribution channel, the wireless distribution signal including the coverage channel information indicating a coverage channel for communication between the mobile station and the distribution station.

16. A base station in accordance with claim 15, wherein the controller correlates the coverage channel information to the distribution channel information by applying a channel translation index to determine an associated distribution channel associated with the coverage channel information.

17. A base station in accordance with claim 16, wherein the controller receives the channel translation index from a channel translation interface.

18. A base station in accordance with claim 15, further comprising a system interface that receives the coverage channel information.

19. A base station in accordance with claim 18, wherein the coverage channel information is a coverage frequency value and the associated distribution channel is a downstream frequency value.

20. A base station in accordance with claim 19, wherein the distribution frequency value represents at least a downstream distribution frequency for transmitting a downstream distribution signal from the base station to the distribution station.

21. A base station in accordance with claim 20, wherein the distribution frequency value represents at least a distribution frequency pair including the downstream distribution frequency and an upstream distribution frequency for transmitting an upstream distribution signal from the distribution station to the base station.

22. A base station in accordance with claim 19, wherein the coverage frequency value represents at least a downstream coverage frequency for transmitting an downstream coverage signal from the distribution station to the mobile station.

23. A base station in accordance with claim 22, wherein the coverage frequency value represents at least a coverage frequency pair including the downstream coverage frequency and an upstream coverage frequency for transmitting an upstream coverage signal from the mobile station to the distribution station.

24. A cellular base station comprising:
a system interface configured to receive coverage frequency value through an Abis interface;
a channel translation interface for receiving a channel translation index from an Operation and Maintenance Center (OMC), the channel translation index correlating a plurality of coverage frequency pair values to plurality of distribution frequency pair values;
a controller that applies the channel translation index to identify a downstream distribution frequency associated with the coverage frequency value; and
a radio interface for transmitting, to a distribution station, a wireless distribution signal at the downstream distribution frequency, the wireless distribution signal including the coverage frequency value indicating a coverage frequency for communication between the mobile station and the distribution station.
